(19) United States
(12) Patent Application Publication
(10) Pub. No.: US 2008/0033740 A1
(43) Pub. Date: Feb. 7, 2008

(54) On-line anonymous age verification for controlling access to selected websites

(76) Inventors: Robert Cahn, Carmel, NY (US); Teresa Piliouras, Weston, CT (US)

Correspondence Address: Wendy W. Koba, Esq., PO Box 556, Springtown, PA, 18081, US

(21) Appl. No.: 11/638,226

(22) Filed: Dec. 13, 2006

Related U.S. Application Data
(60) Provisional application No. 60/835,834, filed on Aug. 4, 2006.

(51) Int. Cl. G06Q 10/00; G06Q 30/00

(52) U.S. Cl. 705/1

(57) ABSTRACT

A universal age verification service is provided where individuals initially register with the service by submitting their birth certificate or other “legally authentic” documentation of age and gender (such as required to obtain a passport) to obtain a “universal ID” comprising a string of alphanumeric digits selected from a hash function that is performed on a string of information including individual's name, gender, birth date and birth location. The string is preferably supplemented by a secret, proprietary pad string known only to the service provider. A selected number of digits from the hash (preferably, at least 9 digits, and possibly, more) is then defined as the individual's “universal age/gender verification ID”. The original documentation papers and generated UAID are then conveyed by mail, in person, or otherwise, to the individual, along with a password. Once registered, the individual's UAID is used to control entry to various websites that have registered with the universal age/gender verification service.

### CROSS-REFERENCE TO RELATED APPLICATION

This application claims the benefit of U.S. Provisional Application No. 60/835,834, filed Aug. 4, 2006, which is herein incorporated by reference.

### TECHNICAL FIELD

The present invention is directed to a service for providing on-line age and/or gender verification for persons attempting to access certain websites and, more particularly, to a service for website providers and individual subscribers that allows anonymous verification of an individual subscriber's age and/or gender prior to being granted access to the provider's website.

### BACKGROUND OF THE INVENTION

Despite a strong desire to shield minors from accessing harmful material on the World Wide Web, a consensus exists that the battle is being lost. The proliferation of online usage has been accompanied by a concomitant rise in the number of young computer users. While the Internet offers access to a wealth of educational, entertainment and other materials of interest to young people, this same “wide open access” allows them to explore websites that are unacceptable for their age group. Various types of “filters” have been created to deny access to certain websites from a specific computer, or set of networked computers. These filters are generally based upon terms and/or ratings associated with specific websites. However, computer-savvy young people may still be able to circumvent these filters and gain access to inappropriate websites. Moreover, such filters do not adequately prevent predators from accessing chat rooms and other websites frequented by pre-teens and teenagers (such as, for example, a “facebook” website, a “myspace” website, which are known to be geared toward younger people).

Further, in public areas providing Internet access (such as, for example, public libraries), if one or more of these filtering screens is employed, they result in also preventing access to certain sites by adult computer users, who would otherwise be able to access this material via the Internet.

The Child Online Protection Act (“COPA”), passed by Congress in October of 1998, mandated the COPA Commission—a congressionally-appointed panel—to identify technological or other methods that would help reduce access by minors to “harmful material” available on the Internet. Congress has determined that widespread availability of the Internet continues to present opportunities for minors to access Internet-based material in a manner that can frustrate parental supervision or control. While Congress has acknowledged that the computer and Internet industries have developed innovative ways to help parents and educators restrict material that is harmful to minors through parental control protections and self-regulation, they have also noted that such efforts have failed to provide a national solution to the problem of minors accessing harmful material on the World Wide Web.

One attempt to address this issue of unwanted access by minors is disclosed in US Patent Application 2006/0173792, submitted by Paul H. Glass and published on Aug. 3, 2006. In the Glass system, limited access to the Internet itself is provided by an Internet Service Provider (ISP) as part of the initial contractual agreement with a subscriber. In particular, in order for a subscriber to obtain Internet access service, the subscriber must first submit registration data (including an encrypted version of his Social Security number, or another type of authentic identification data), printed on a paper form and hand-delivered to a designated ISP location. An authorized agent or employee at the ISP location then verifies that the potential subscriber is indeed the same person for which the ISP registration is to be issued. If the subscriber verification is successful, s/he is allowed to complete an “access contract” with the ISP.

While this method would likely identify underage registrants during the registration process (thereby blocking children/teens from entering into an Internet access contract with a specified ISP), it may still be subverted by younger members of the same household gaining access to websites that only the parents should be allowed to visit. Moreover, the Glass et al. method does not prevent predators (or adults in general) from gaining access to “teen-only” chat rooms and websites.

Thus, a need remains in the art for providing a more universal “age/gender verification” process that may be used to control an individual's ability to access various websites, preferably on a website-by-website basis.

### SUMMARY OF THE INVENTION

The need remaining in the prior art is addressed by the present invention, which relates to a service for providing on-line age/gender verification for persons attempting to access certain websites and, more particularly, to a service for website providers and individual subscribers where the provider requires an anonymous verification of an individual's age and/or prior to granting access to the provider's website.

In accordance with the present invention, a universal age verification service is provided where individuals initially register with the service by submitting their birth certificate or other “legally authentic” documentation of age and gender (such as required to obtain a passport) to obtain a “universal ID”. The universal ID created by the service comprises a string of alphanumeric digits derived from a hash string computed using the individual's name, gender, birth date and birth location (and perhaps other information), in conjunction with a secret, proprietary pad string known only to the service provider. A selected number of digits from the hash (preferably, at least 9 digits, and possibly, more) is then defined as the individual's “universal age/gender verification ID” (hereinafter referred to as “UAID”). The original documentation papers and generated UAID are then conveyed by mail, in person, or otherwise, to the individual, along with a “secret user string” (analogous to a password and hereinafter referred to as “SUS”). Once registered, the individual's UAID is used to control entry to various websites that have registered with the universal age/gender verification service.

In order for the age/gender verification service to be utilized, website owners must also register with the service provider. The registration requires the owner to provide the various URLs for which the service is desired, as well as defined age/gender parameters for each URL. Thereafter, when an individual attempts to enter a subscribed-to website, the individual will be prompted to transmit both his UAID and SUS information to the website. In turn, the website will forward this information, augmented with other information (e.g., the individual's IP address), to the age/gender verification service provider, in order to verify that the individual's age and/or gender is appropriate for entry into the website.

The UAID age/gender verification service of the present invention generates a hash string using the augmented submission string supplied by the website. The service also produces a second hash string using the previously-stored individual UAID, secret user string and other information residing in UAID servers. The two hash values are then compared by the UAID service provider. If there is a match, the UAID age/gender verification service then retrieves the individual's birth date information from the database (otherwise, an “access denied” message is returned to the website). The individual's current age is calculated, based on the birth date, and compared against the “age/gender policy parameters” associated with the subscribed website (for example, the website may be associated with a teen magazine and may wish to restrict access to those in the age range of 13-18). If the individual's age (and gender, when defined) is within the website guidelines (e.g., the individual is fifteen years old), an “access permitted” message is sent by the service to the website. Otherwise, if the individual's age and/or gender is outside of the defined range, an “access denied—over/under age (or wrong gender)” message is sent to the website.

It is to be noted that no information specifically relating to the individual's age, gender or identity is transmitted by the UAID service to the website subscriber during this verification process. After the verification process is complete, other transactions and/or on-line interactions between the individual and website may proceed without further interaction with the UAID service. Thus, the UAID age/gender verification service of the present invention remains an anonymous third party to the transactions between the registered individual and the various subscribed websites.

In accordance with the present invention, various accepted “one way” hashing techniques may be used by the service to preserve the anonymity, integrity and security of transmissions between individual subscribers, website subscribers and the inventive UAID age/gender verification service. For example, the MD5 or SHA-1 hash techniques, well known in the art, may be used for this purpose. Alternatively, the implementation may use a proprietary one-way hash that has not been published and will be, as a result, even more secure. In a preferred embodiment of the present invention, a nine-digit UAID is used.

The UAID platform of the present invention can further check the to-be-assigned UAID against UAIDs that have already been issued, and thereby avoid a “collision” which occurs when a hash string is produced that matches a previously-issued UAID. If a collision occurs, the process will adjust one (or perhaps more) of the digits in the to-be-assigned UAID and again search the issued UAID database for collisions. This process, well known in the art as “open hashing”, would continue, as necessary, until the newly-formed UAID is “unique”.

In the process of generating the UAID, a “pad string” known only to the service provider may be appended to the supplied information, providing additional assurance that inappropriate third parties cannot generate fake UAIDs or submission strings and thereby misrepresent themselves as being associated with (or an agent of) the age/gender verification service.

Various techniques known in the art may be used in conjunction with the inventive age/gender-verification service to provide additional security to the generation and utilization of this information. For example, time-limited tokens may be provided to subscriber websites by the age/gender verification service provider. When an individual attempts to enter a subscriber website, the website returns one of the tokens, which must then be used by the individual to initiate the verification service. The generation and transmission of the token between the verification service, website and individual is controlled by software provided by the verification service. The use of tokens is intended to make it more difficult for unauthorized website operators or others to intercept messages transmitted during the verification process and attacking them with cryptographic techniques (“hacking”). Other techniques, such as requesting the individual's IP address, monitoring the timestamps of verification requests, and the like will be useful in discovering when a UAID has been compromised or shared.

Other and further variations and embodiments of the present invention will become apparent during the course of the following discussion and by reference to the accompanying drawings.

### BRIEF DESCRIPTION OF THE DRAWINGS

Referring now to the drawings,

FIG. 1 contains an exemplary flowchart illustrating the process of obtaining a universal age/gender-verification ID (UAID) in accordance with the present invention;

FIG. 2 presents an exemplary network architecture for implementing the age/gender verification service of the present invention;

FIG. 3 illustrates, in more detailed form, the particulars of an exemplary UAID platform formed in accordance with the present invention;

FIG. 4 contains a “process flow” diagram illustrating the utilization of a UAID in accordance with the present invention;

FIG. 5 is a flowchart illustrating an exemplary process of performing age verification, based on a submitted UAID, in accordance with the present invention; and

FIG. 6 contains an alternative “process flow” diagram, in this case illustrating the use of tokens to increase system security.

### DETAILED DESCRIPTION

The “universal age/gender-verification ID” (UAID) service of the present invention is intended to be a third party service offered to individuals (as “users” of the Internet) and organizations (as “owners” of websites). In general, an organization that subscribes to the UAID service of the present invention can then advertise their website(s) as utilizing an age- and/or gender-restricted policy, providing additional assurances to parents, educators and others that are concerned about controlling Internet access for young people, or keeping predators off of sites intended for only young people. Parents and/or educators and the like may then register each individual in the family (or a blanket registration for a school), where each individual will have: a) his/her own UAID created for use thereafter, and b) his/her personal secret string (SUS).

As will become apparent during the course of the following discussion, the age verification service of the present invention includes two distinct aspects: (1) the creation of a “universal age-verification ID” (UAID) for individuals who desire to register for the service; and (2) the subscription of websites for utilization of age/gender-based access for their websites. The following will first describe an exemplary process for creating a UAID for an individual, and then describe the subscription and use of UAIDs by website owners desiring to control access.

A. Individual Registration—Creation of a “Universal Age ID”

The process of obtaining a UAID begins with an individual submitting general identification information, along with their original birth certificate (or other “legally verifiable identity documents”), to the UAID service provider. Similar to the process of obtaining a passport, a critical component of the age verification service of the present invention is the submission of a tangible, physical document that may be separately authenticated by the service provider. The provided data may be stored by the service provider in tabular form, as showed below in Table I for an exemplary individual “James Doe”:

TABLE I

| Data Element | Value |
|---|---|
| First Name | James |
| Middle Name | NMI (no middle initial or name) |
| Last Name | Doe |
| Mother's First Name | Laura |
| Date of Birth | Jul. 1, 1980 |
| City of Birth | New Rochelle |
| State of Birth | New York |
| Country of Birth | United States |
| Gender at Birth | Male |
| Other Data from Identity Document | 23 |
| (i.e., mother's age at child's birth) | |

The process of creating a unique UAID for James Doe based on this information then proceeds by formatting this data into a standard string (SS) form as follows:

### SS=James,NMI,Doe,Laura,July,01,1980,New_Rochelle,New_York,United_States,

where the “underscore” character is used in each instance where a “blank” is required. It is to be understood that in its most general implementation, a subset of these data element values may be used to form the standard string (for example, “mother's first name” may be omitted from the standard string). The arrangement as shown above is considered as exemplary only. The next step, in accordance with the present invention, is to append a “pad string” to the standard string. The inclusion of a “pad string” known only by the UAID service provider avoids the creation of “fake” IDs by an untoward individual or entity misrepresenting themselves as a bona fide agent of this UAID service. In many ways, the pad string can be likened to a “private key” in a (public key, private key) pair. For the purposes of explanation, it is presumed that the UAID service is currently using the pad string: NowWeLearnOurABCs, appending this string to that shown above to form the complete string:

### James,NMI,Doe,Laura,July,01,1980,New_Rochelle,New_York,United_StatesNowWeLearnOurABCs

### It is to be understood that the particular “pad string” used the by UAID service may be changed periodically to further limit the possibility of the UAIDs being compromised.

A key step in the formation of unique, verifiable UAID is to generate a one-way hash of the complete string, where a portion of the hash is then defined as that individual's unique UAID. Exemplary well-known hashes that may be used for this purpose include, but are not limited to, MD4, MD5 and SHA-1. The following discussion will utilize the MD5 hash to generate the translated string only for the purposes of further explaining the additional attributes of the present invention. For the complete string as shown above, the resultant MD5 hash is the 32 hexadecimal digit number shown below:
39def8211dba37211f46a73bd81f129d
   Obviously, such a random appearing 32 digit number is too long to be remembered by James Doe and would thus not be acceptable for use as a UAID that needs to be remembered and used on a regular basis as different websites are visited. The number of possible permutations of this string is 16³²—a significant indication that such a long string would be “overkill” in providing a secure ID. The following Table II lists the possible number of permutations that may be represented by “n” hexadecimal digits, for values from n=1 to n=14:

TABLE II

| “n” | Permutations |
|---|---|
| 1 | 16 |
| 2 | 256 |
| 3 | 4096 |
| 4 | 65,536 |
| 5 | 1,048,576 |
| 6 | 16,777,216 |
| 7 | 268,435,456 |
| 8 | 4,294,967,296 |
| 9 | 68,719,476,736 |
| 10 | 1,099,511,627,776 |
| 11 | 17,592,186,044,416 |
| 12 | 281,474,976,710,656 |
| 13 | 4,503,599,627,370,500 |
| 14 | 72,057,594,037,927,900 |

Seven digits (n=7) represents approximately the total population of the United States, and eight digits (n=8) represents approximately the world's population. For the purposes of the present invention, either of these two values would probably suffice. In order to minimize the possible future need to change (i.e., increase) the number of digits required to provide a unique UAID for all possible individuals, the value of nine digits (n=9) will be utilized for the preferred implementation of the UAID service of the present invention. Thus, for a particular embodiment of the present invention, the last nine digits of the MD5 hash string will be defined as James Doe's UAID. That is, recalling that the MD5 hash created by James Doe's personal information is as follows:
39def8211dba37211f46a73bd81f129d,
   the string “bd81f129d” (the last nine digits as indicated by the “bold” typeface) will be sent to James Doe (presumably through the mail, or other secure method of transmission) as his personal UAID. For the ease of remembering this string, it may be broken into its triplet form: “bd8 1f1 29d”. Inasmuch as people routinely memorize their nine-digit Social Security number, it seems reasonable they will also be able to memorize their UAID. Since any slight modification of the input data (for example, the inclusion of a middle initial for Mr. Doe) will significantly change the hash result, it is a valid presumption that the nine digits generated for the UAIDs requested by a large number of individuals will all be unique.

To provide further assurance of “unique-ness” of the assigned UAID, the age verification service of the present invention may first check the to-be-issued UAID against all previously-issued values. If a “match” is found (oftentimes referred to as a “hash collision” in the encryption arts), one digit of the UAID may simply be incremented (or decremented) one value, and the modified UAID again checked; with this process continuing until a truly “unique” UAID can be assigned and issued to James Doe. It is considered that the possibility of a collision will be rare, but if such an event does occur, the simple increment/decrement solution is available.

While this particular example utilizes the last nine digits of the hash, it is to be understood that any pre-defined set of nine digits (or other desired number of digits) may be used. For example, the first nine digits may be used to form the UAID, or the first five digits and the last four digits, or any other combination as dictated by the service provider.

When the UAID value is communicated to James Doe, the UAID service of the present invention will also provide a “secret user string” (i.e., password) that James Doe must use in conjunction with his UAID to gain access to various sites, as will be discussed in detail below. The number of bytes used to encode the secret user string will depend upon the security requirements of the UAID service provider. For example, a high security application might require a secret string of 1024 bytes, while a less secure application may need a secret key that is only 64 bits long. In this case, the keys can either be encoded as 16 hexadecimal digits (4 bits/character) or as 11 printable ASCII characters (6 bits/character). It is presumed that a secret user string as used in accordance with the present invention might need to be entered only once into a crypto key-ring (such as are available on personal computers running the Linux operating system) or other device (e.g., smartcard) for easy storage and use. For the purposes of the present invention, it is presumed that the “secret user string” nobodyknows is sent to James Doe to be used in conjunction with his UAID. Importantly, the UAID service provider stores the UAID/“secret string” pair in its database of registered users, where these values are later retrieved (as will be discussed in detail below) in each instance where an individual desires to access a website that has subscribed to the UAID service. In accordance with another aspect of the present invention, the age/gender verification service may periodically update or re-issue the secret key, based on factors such as time restrictions (i.e., “expiration date” of a key), user request, security needs, or the like.

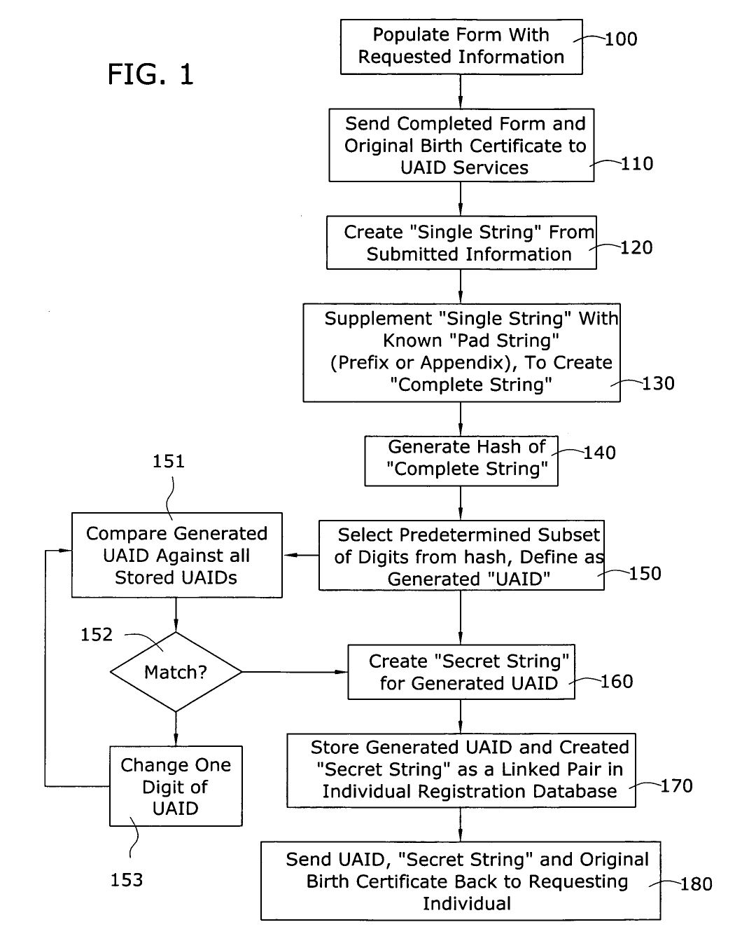

FIG. 1 contains an exemplary flowchart summarizing this process of obtaining a unique UAID as outlined above. As shown, the process begins with the individual completing a form (template) of the required information (step 100). The completed form and a “valid” certification document (preferably, an original birth certificate, passport, or the like) are then sent to the UAID service provider (step 110). Presumably, the form and associated documentation is sent by mail (certified mail or the like) or personally delivered to an office or agent of the UAID service provider. A “standard string” (SS) is then created from selected portions of the submitted information, where the selection is at the discretion of the UAID service provider (step 120). A “pad string” that is known only to the UAID service provider is then appended to (or prefixed to, as the case may be) the SS to form a complete string (step 130). A hash calculation is then performed on the complete string to generate a relatively long hexadecimal result (step 140), with a predetermined number of digits from the hash defined as the UAID for the individual (step 150).

A “secret user string” is then assigned to the generated UAID (step 160), and both the UAID and secret user string are stored in a UAID database under the control of the UAID service provider (step 170). The generated UAID, secret user string and original birth certificate (or other form of submitted authentication) are then delivered to the requester (step 180). It is presumed that some type of mail/e-mail direct delivery service is used to send the information to the requester. Once the individual has received his unique UAID and associated secret user string, he may use this identifying information to gain access to subscribed-to websites that permit person's of his current age. The process associated with obtaining access to subscriber websites is described in detail hereinbelow.

In one preferred implementation of the present invention, a generated UAID may be first checked against all previously-issued UAIDs to ensure that a “collision” will not occur (that is, that the same UAID is sent to two different individuals). As mentioned above, one intention of the present invention is that the UAID will be unique to each registered individual. The flowchart of FIG. 1 contains an additional set of steps 151-153 that may be used to provide a collision check prior to assigning a UAID. As shown, once a UAID has been generated in step 150, the process can move to step 151, which will then compare this generated valid against all other UAIDs stored in database 14. Step 152 is used to check for a “match”. If there is no match, the process returns to step 160, and a “secret string” is created for the UAID. Alternatively, if there is a match, the process moves to step 153, which then changes one or more digits in the generated UAID (for example, incrementing or decrementing a selected digit) and returns to step 151 to perform a comparison of the modified UAID against the database. This process of comparing will continue until a UAID is created that does not “collide” with any of the previously-issued UAIDs, and also preserves the ability to recover a UAID should it be lost (utilizing a linear search starting with the value first computed at step 150).

B. Website Owner Subscription and UAID Platform Architecture

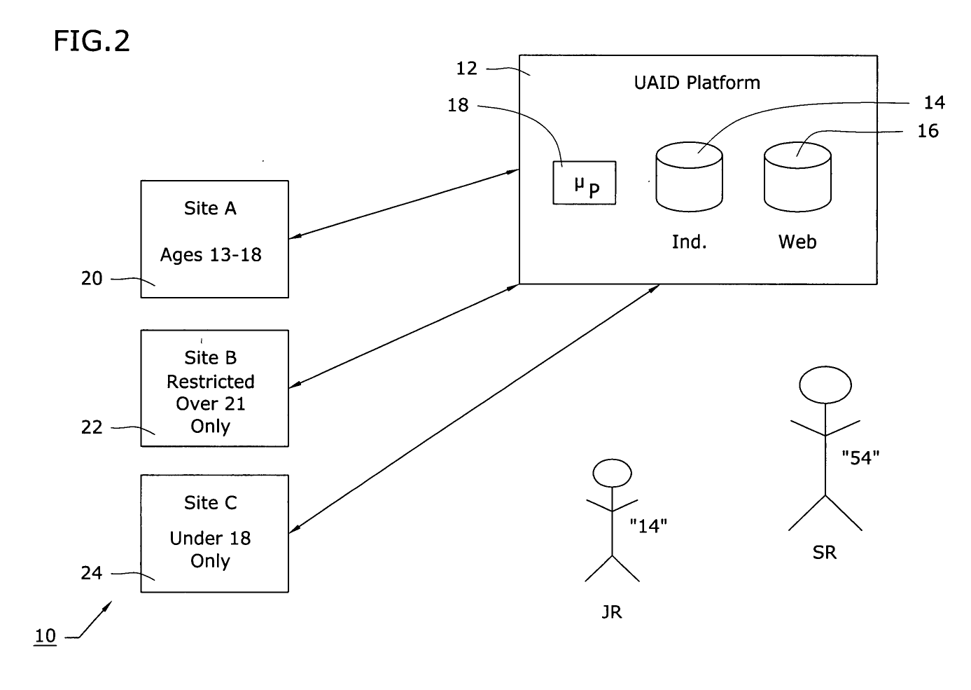

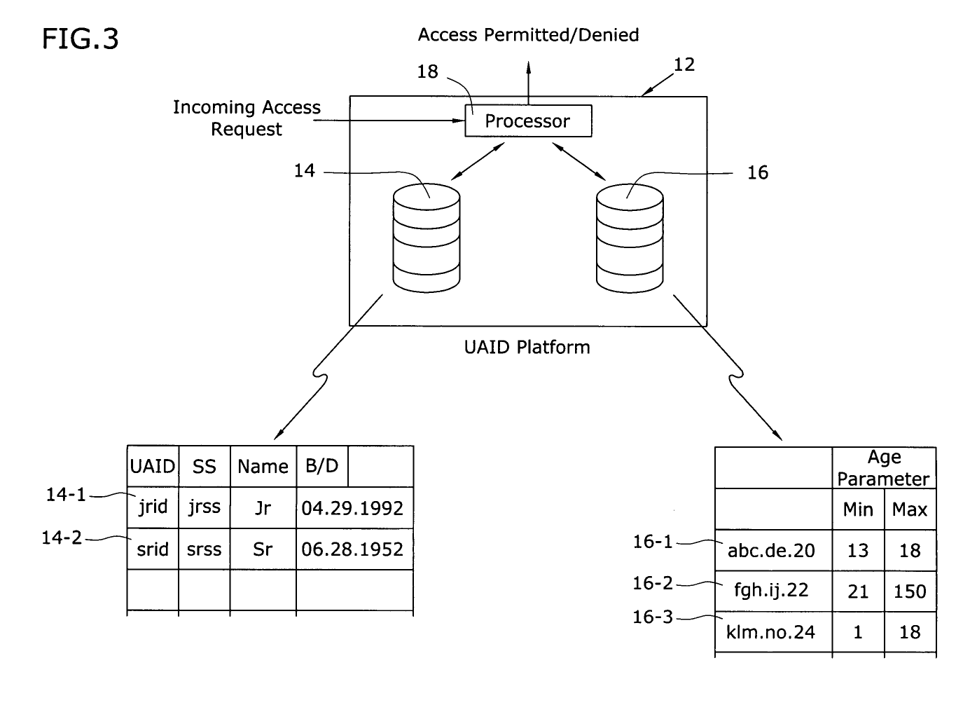

FIG. 2 illustrates, in a simplified view, an exemplary network arrangement 10 for supporting UAID access control to subscribed-to websites in accordance with the present invention. Contained within network arrangement 10 is an exemplary UAID platform 12 formed in accordance with the present invention. As shown and as will be explained in detail hereinbelow in association with FIG. 3, UAID platform 12 includes an individual subscriber database 14, a website owner database 16 and a processor 18 capable of performing, among other processes, the particular hash function (such as the MD5) used to create the UAIDs in accordance with the present invention. Also illustrated in network arrangement 10 is a set of three separate websites 20, 22 and 24 that have previously subscribed to the real-time age verification service provided through UAID platform 12. Two individuals, denoted as “Sr.” and “Jr.” are also illustrated in FIG. 2, where it is presumed that these two individuals have registered for the age verification service of the present invention.

FIG. 3 illustrates, in more detailed form, the particular information stored at UAID platform 12. Individual subscriber database 14 is shown as comprising a plurality of separate records 14-1, 14-2, . . . , where each record contains the initial registration information for each subscriber. As described above, the process of populating the individual subscriber database is accomplished by personnel associated with the service provider—an individual is not capable of entering his/her own data into the database. Record 14-1 is particularly shown in this case as associated with registered user “Jr.”, and includes Jr.'s generated UAID, secret user string, birth date, and perhaps additional information. For the purposes of age verification, only the birth date information is essential. When a “gender” verification is required, obviously the recorded “gender at birth” will also be included as essential information. Record 14-2, associated with registered user “Sr.” includes similar information. Inasmuch as “birth date” data is stored (as opposed to current age information), there is no need to update a record once created (unless an error is discovered).

Website subscriber database 16 also includes a plurality of separate records, where each record is associated with a particular registered website, or a registered partition of a particular website. Record 16-1, as shown, is in this case associated with website 20, and includes both its IP address (or URL), its age-defining information—“MIN” and “MAX”, and/or gender restrictions (“MALE” and “FEMALE”) when gender-based restriction policies are used. The website's age/gender restriction policies will then be used by platform 12 to determine if an individual will be permitted access to website 20. Various other means of defining the age limitations and other parameters associated with the subscribed websites may be utilized. Similarly, record 16-2 contains the information associated with website 22 and record 16-3 contains the information associated with website 24. It is presumed that website owners will be permitted to subscribe and unsubscribe, as need be.

C. Operation of Age Verification Service

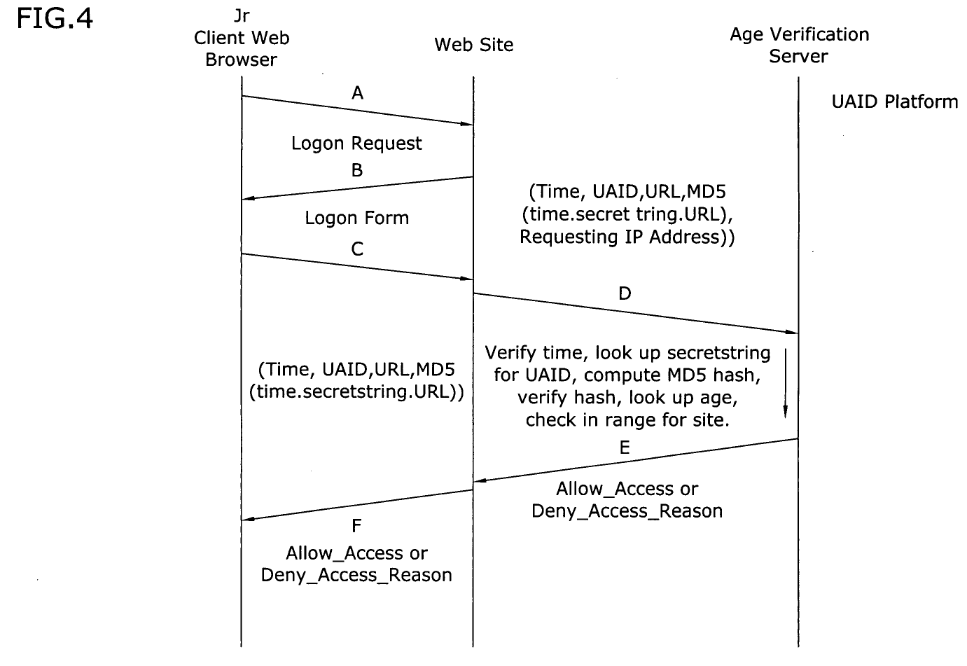

With this understanding of the process of obtaining a UAID and the overall network architecture for implementing the UAID age verification service, the specific operation of this service will now be described in detail. FIG. 4 contains a “process flow” diagram illustrating the interactions between a registered individual, a subscribed web site and the UAID service platform formed in accordance with the present invention.

For the purposes of discussion, the flow will be described from the perspective of individual “Jr.” attempting to access each of the subscriber websites 20, 22 and 24 as defined above in association with FIGS. 2 and 3. Initially, it is presumed that Jr. wishes to gain access to website 20. Jr. will then send a conventional “logon request” (denoted A in the process flow of FIG. 4) to website 20. In return, since website 20 is a subscribed-to, “restricted access” website requiring age verification, website 20 will return a “logon age verification form” to Jr. (denoted B). This form may also include, as discussed in detail below, a time-limited token provided by the age/gender verification service to the subscriber website. It is to be understood that if website 20 had not previously subscribed to the inventive age verification service, Jr may merely be asked to “verify” if he is of an age suitable for this website (the “honor system”, so to speak).

Presuming that website 20 is registered with the inventive service, the logon form will request that Jr. enter the following information: current time, UAID, URL, and a hash defined as: MD5 (time.UAID.secretuserstring.URL), where Jr.'s local computer will generate a hash of the italicized information. It is to be understood that the inclusion of data such as “time” and “URL” in the generated hash value will add to the overall security of the system. In its most basic implementation, it is possible to utilize only a hash of the “secret user string”, since this is the only data that is not transmitted in the clear and can be used as a validation check by the UAID platform. Other implementations using current time, URL of the website, and other data in the hash string may be used in applications requiring greater security.

Referring to FIG. 4, the return message (denoted C) from Jr. to website 20 will comprise: time, UAID, URL, hash. At this point, website 20 will append Jr.'s computer IP address to this string and submit it to UAID platform 12, following a request for age verification (denoted D):

time, UAID, URL (of website), hash, IP address (of Jr.'s computer).

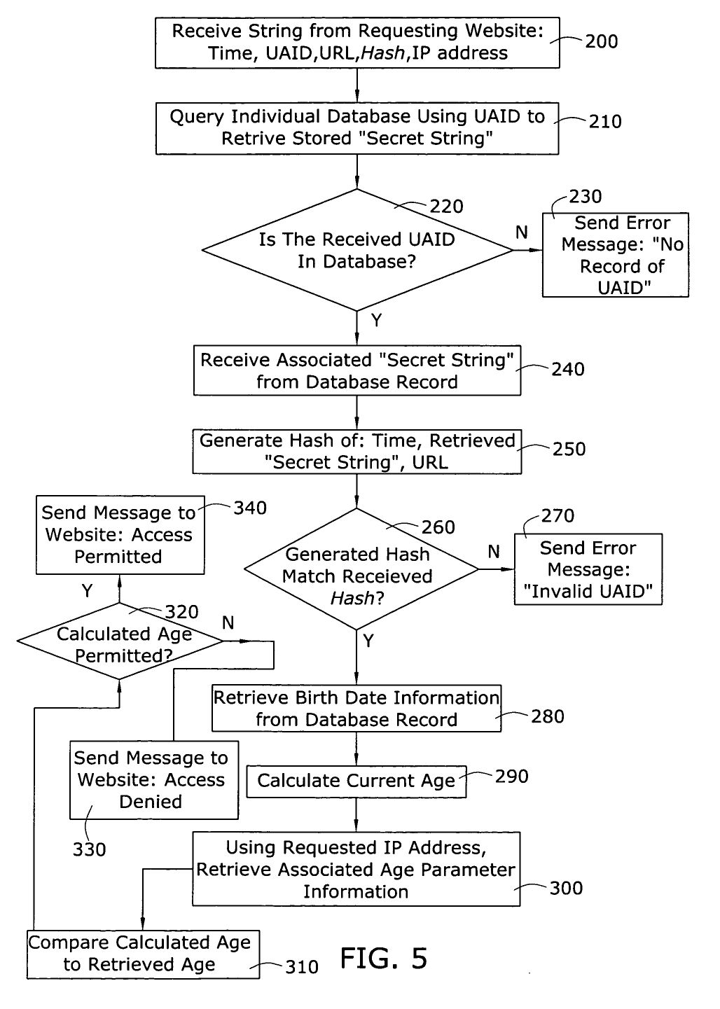

In accordance with the present invention, UAID platform will then perform a verification process, as outlined by the flowchart of FIG. 5 discussed below, to make the following sequential determinations: (1) authenticate the UAID; (2) determine the age and/or gender of the individual associated with the UAID; (3) compare the determined age/gender against the age/gender restriction information of the requesting website; (4) return a message “access permitted” or “access denied” to the requesting website (denoted E). Upon receipt of the access request/denied message at website 20, this information will be forwarded to Jr. (denoted F).

The flowchart of FIG. 5 illustrates the processes occurring at the UAID platform associated with authenticating a registered individual and validating his ability to enter a specific, subscribed-to website. As shown, the process begins at step 200 with the UAID platform receiving a “request” from a registered website, the request in the form of the string provided in flow step D, as noted above. The UAID platform first checks that the current time is within a specified window (for example, 30 seconds). The UAID platform then uses the received UAID to query the individual database 14 and retrieve the associated “secret user string” (step 210). If the UAID is not found (step 220), an error message (i.e., “bad UAID”) is transmitted to the website (step 230). Otherwise, the appropriate “secret user string” is retrieved (step 240), and processor 18 at UAID platform 12 generates a hash (using the same algorithm as used in the initial formation of the UAID) of: time, retrieved “secret user string” and URL (step 250). A comparison is then made between the received hash and the generated hash (step 260). If there is no match, an error message (“bad hash”, invalid UAID) is sent to the website (step 270).

Presuming that the hash matching is successful, the process continues (step 280) with the retrieval of the actual “birth date” information of this individual, as contained within his record in database 14. The actual “birth date” information is then used to calculate his current age (step 290). The age restriction information is then retrieved from the web subscriber database 16 (using the submitted IP address of the requesting website)—step 300, and the age restriction information is compared against the calculated age of the requesting individual (step 310).

A determination is made at step 320 regarding permission to access the website, where if the individual's current age falls outside of the defined age restriction information, an “access denied” message is sent to the website (step 330). Otherwise, an “access permitted” message is sent to the website (340). It is to be noted that in either case the individual retains his “anonymity” with respect to the database. That is, the returned message is either “permitted” or “denied”; the specific age or identity of the requesting individual is not divulged. Subsequently, internal service logs documenting the individual and website verification activity may be updated (step 350), and then be available for various audit and verification purposes.

Applying the steps outlined in FIG. 5 to the specific example given above, upon determining that Jr.'s UAID is indeed a registered UAID, the process continues by retrieving the stored secret user string from record 14-1 in database 14. Processor 18 then computes a hash of the received “time”, UAID, retrieved secret user string and received “URL”. If this hash matches the received hash value (sent along message path D), the received UAID is verified and the process continues. Otherwise, if the generated hash does not match the received hash, an error message will be sent from platform 12 to website 20, stating that an incorrect/invalid UAID was presented. Presuming that a match occurs, processor 18 then proceeds to retrieve the “birth date” information from, in this example, record 14-1, and calculate the current age of Jr. The calculated age, based on the information shown in FIGS. 2 and 3, is “14”. This value is compared against the age restriction definition for website 20, stored in record 16-1 of database 16. In this case, the definition is “age range 13-18”. Since Jr.'s current age is within this range, platform 20 will transmit an “access permitted” message to website 20, and Jr. will be permitted to gain access to the website.

In contrast, if Jr. were attempting to enter an “over 21” website, such as website 22, the age verification service of the present invention will deny his access to that website. That is, once Jr.'s current is determined (i.e., “14’), this age would be compared against the age restriction policy for website 22, as stored in record 16-2 of database 16. As shown in FIG. 3, the “MIN” age for this website (see record 16-2 of database 16) is 21. Since Jr.'s age fails this “MIN” test, an “access denied” message will be sent to website 22.

It is to be noted that in either case, Jr.'s actual age is not transmitted to the website, only a permit/deny access message. This is considered to further provide anonymity to the users of the service.

In a similar fashion, Sr.'s access to websites may be controlled through the application of the age/gender verification service of the present invention. For example, presuming that Sr desires to gain access to a “teen only” website, such as website 20, a calculation of his current age as “54” will deny him access. Thus, this application of the present invention is seen to provide the “predator” safeguard desired by parents, educators and others involved with youth. Furthermore, if at some future time convicted child molesters are required to register with the UAID service, this registration would further reduce the potential for sexual predators to misrepresent themselves and gain access to youth-related websites.

There exist many variations that may be utilized with the age/gender verification service of the present invention to further lessen the opportunity for “hackers” and non-legitimate users to gain access to either the UAID platform or the registered websites. For example and as mentioned above, the UAID platform may generate “tokens” on a regular basis that are supplied to registered websites. The use of tokens, as known in the art, may be utilized to provide time-sensitive control information to web-based interactions. That is, the tokens supplied to a registered website may have a “shelf life” of, for example, five hours. After that time period, the tokens will expire and anyone attempting to use expired tokens to gain access to the UAID platform will be denied. Further, tokens will only be able to be used a single time—thus defeating “replay” attacks where information is copied and re-submitted.

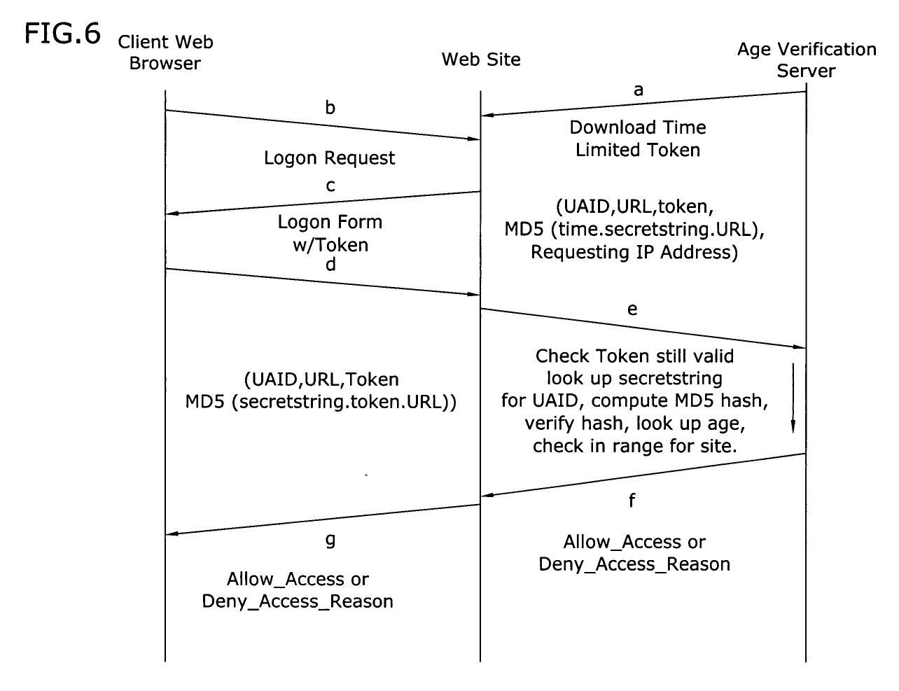

FIG. 6 illustrates an exemplary age/gender verification process flow of the present invention when utilizing tokens for further security. In this case, the first step (denoted as “a” in FIG. 6) is the transmission of one or more tokens from UAID platform 12 to a registered website (such as website 20). At some later time, a potential web site user will transmit a “logon request” to website 20 (denoted “b”) as in the process discussed above. In this case, website 20 will transmit both the logon request form and a selected token to the individual (c), then removing the transmitted token from its list of available tokens. The individual then responds with the requested information, where the received token is inserted in the string of requested information, as shown in step d of FIG. 6. As before, website 20 will append its IP address to this information string, and forward the complete string to UAID platform 12.

In accordance with this embodiment of the present invention, UAID platform 12 will first check the validity of the received token. If the token value has expired, or is not a valid token, an error message will be returned to website 20. If the token is found to be valid, the process will continue in the same manner as outlined above, performing further checks on both the UAID itself and the “hash” of the retrieved secret user string before calculating the individual's age and either permitting or denying access.

Other means of providing additional security to the age verification process of the present invention may involve an analysis of the “time” portion of the data transmitted to the UAID platform, where a repeated number of attempts to validate and process a UAID may signal the work of a hacker. In order to dissuade individuals from giving their UAID/secret string pair to others (similar to over-age young adults purchasing beer for their younger friends), the service of the present invention may require the individual to transmit his current IP address information to gain access to selected websites. This can be performed automatically using software provided by the verification service. If a particular UAID/secret user string pair is received from a multiple number of different IP addresses, it may be presumed that this information has been compromised and the UAID may be “frozen”. Additionally, at the option of both the verification service and the subscribers, various activity logs of individual and website verification requests can be created for review.

Other and further modifications and embellishments to the age verification service of the present invention will become apparent to those skilled in the art. Indeed, the subject matter of the present invention is intended to be limited in scope only by the claims appended hereto.

What is claimed is:

1. A method of creating a universal age/gender identification (UAID) for controlling access by individual users to subscribed websites, the method comprising the steps of:
a) receiving, at a UAID service provider, legally-recognized documentation of birthdate/gender of an individual requesting registration;
b) creating a string of selected information from the received documentation;
c) supplementing the created string with a pad string of information known only to the UAID service provider to form a standard string;
d) generating a hash of the standard string created in step c);
e) defining a predetermined subset of digits from the generated hash as the individual's UAID;
f) creating an initial password for use in association with the individual's UAID;
g) storing the (UAID, password) pair in a database of registered users; and
h) delivering the UAID, password and legally-recognized documentation to the registered subscriber for subsequent use in accessing subscribed-to websites.

2. The method as defined in claim 1, wherein in performing step d), the MD5 one-way hash is used.

3. The method as defined in claim 1, wherein in performing step d), the SHA-1 one-way hash is used.

4. The method as defined in claim 1, wherein in performing step d), a proprietary one-way hash is used.

5. The method as defined in claim 1, wherein in performing step e), at least seven digits from the hash are used to define the UAID.

6. The method as defined in claim 5, wherein in performing step e), at least nine digits are used to define the UAID.

7. The method as defined in claim 1, wherein prior to performing step f), the UAID created in step e) is first checked against all previously-supplied UAIDs and, if a duplicate is found, modifying the UAID of step e) to eliminate the duplication.

8. The method as defined in claim 7 wherein the checking is performed for the modified UAID in a continuing manner to ensure that the modified UAID is not a duplicate.

9. The method as defined in claim 7 wherein the created UAID is modified by incrementing the least significant digit.

10. The method as defined in claim 9 wherein the created UAID is incremented in value using arithmetic base 16.

11. The method as defined in claim 9 wherein the created UAID is decremented in value.

12. A method of providing anonymous, third party access control to age/gender restricted websites based upon universal age/gender identifications (UAIDs) associated with registered individuals, each registered individual having a unique UAID, the method comprising the steps of:
a) receiving an access request from a subscribed website for an individual attempting to accessing the subscribed website, the access request including an individual's UAID and information identifying the subscribed website;
b) authenticating the received UAID and, if invalid, transmitting an “access denied” message to the requesting website, otherwise;
c) determining age/gender information associated with the authenticated UAID;
d) comparing determined age/gender information to age/gender parameters associated with requesting website; and
e) transmitting either an “access permitted” or “access denied” message to requesting website based on the comparison of step d).

13. The method as defined in claim 12 wherein the access request received in step a) comprises at least the individual's UAID and a hash of a password assigned to the individual.

14. The method as defined in claim 13 wherein the access request further comprises the current time and IP address information, the additional information utilized to reduce the possibility of illegitimate requests.

15. The method as defined in claim 12 wherein in performing step b) the following steps are performed:
1) comparing the received UAID against a database of all registered UAIDs;
2) if the received UAID is not found in the database, sending an error message to the requesting website, otherwise;
3) retrieving the individual's password from the database;
4) generating a hash of the retrieved password and the other information used to create a one-time hash;
5) comparing the generated hash of step b4) to the password hash received in step a); and
6) if the hash values match, proceeding with the process of step c), otherwise sending an “invalid UAID” error message to the requesting website.

16. An arrangement for providing anonymous, third party access control to registered websites, the arrangement comprising:
a first database of registered individuals, each record associated with a separate individual and including: (1) a unique universal age/gender identification (UAID) associated with the individual, (2) a password, and (3) verified birthdate/gender information;
a second database of registered website, each record associated with a separate website and including: (1) information defining the website, (2) permissible age range information; and (3) gender-based restriction information, if appropriate;
a processor for: generating a hash of stored password information for validating individuals requesting access, determining “current age”/gender information based upon the birthdate/gender information stored in the first database; comparing the determined age/gender information to information stored in the appropriate record in the second database; and transmitting access control information to the requesting website based upon compared information.
